(19) United States
(12) Patent Application Publication
(10) Pub. No.: US 2007/0116866 A1
(43) Pub. Date: May 24, 2007

(54) Quick method for repairing damage to a finish on a substrate

(75) Inventor: Edward J. Mich, Waterville, OH (US)

Correspondence Address: BASF CORPORATION;Patent Department, 1609 BIDDLE AVENUE, MAIN BUILDING, WYANDOTTE, MI, 48192, US

(73) Assignee: BASF Corporation, Southfield, MI (US)

(21) Appl. No.: 11/283,588

(22) Filed: Nov. 18, 2005

(51) Int. Cl. B05D 3/00; B05D 1/36; C08F 2/46

(52) U.S. Cl. 427/140; 427/487; 427/402

(57) ABSTRACT

A method repairs damage of a finish on a substrate. The method applies an ultraviolet-curable (UV curable) primer composition to the area of damage and force flashes the primer composition. Light is irradiated to cure the primer composition and form a cured primer layer. Next, a basecoat composition is applied to the cured primer layer. The basecoat composition is force flashed to form a dried basecoat layer. A UV curable clearcoat composition is then applied to the dried basecoat layer, and the UV curable clearcoat composition is force flashed. Light is irradiated to cure the UV curable clearcoat composition and form a cured clearcoat layer.

### FIELD OF THE INVENTION

The subject invention generally relates to a method of repairing an area of damage of a finish on a substrate. More specifically, the subject invention relates to use of ultraviolet-curable compositions and force flashing to quickly repair damage to the finish on the substrate.

### BACKGROUND OF THE INVENTION

Various methods of repairing an area of damage of a finish on a substrate, such as body panel of a vehicle, are known in the art. Such methods are employed in both original equipment manufacturer (OEM) production facilities and in refinish repair facilities to return the finish to its original color and/or appearance on the substrate after the area has been damaged. The area of damage may result from an accident, such as a collision, in the facility or may simply result from an error during application of original coating compositions to produce the finish.

Generally, such methods include preparing the area of damage. Various techniques for preparing the area of damage include cleaning, sanding, grinding, wiping, blowing, and application of a body filler. Once the area is appropriately prepared, these conventional methods typically apply a primer composition, a basecoat composition, and a clearcoat composition to return the finish to its original color and/or appearance.

The various methods of repair in the prior art are deficient for one reason or another. Overall, most methods of repair in the prior art take too much time to complete the repair.

Many prior art methods employ compositions that are based on isocyanates. As is known in the art, isocyanates are used in repair methods in an effort to minimize the time and cure temperatures required to complete the repair method. However, it is also known that isocyanate-based compositions are frequently prohibited and may be hazardous to one's health when applied without the appropriate care and/or protective equipment. For example, isocyanate-based compositions are prohibited in many OEM production facilities.

Melamine-based compositions, which are an alternative to isocyanate-based compositions, have been also been used in prior art repair methods. However, compositions based on melamine that are used in the prior art repair methods typically produce finishes with poor durability and are both energy and time intensive. For example, melamine-based compositions, even those specifically designed for low cure conditions, take at least 15 minutes to cure at temperature exceeding 180° F. To accomplish cure of the compositions in such times and temperatures, the conventional methods typically rely on irradiation of infrared light which can be energy intensive and, as a result, costly especially as compared to irradiation of visible and/or ultraviolet light.

Prior art repair methods that rely on visible and/or ultraviolet light are also known. These prior art repair methods are also deficient for one reason or another. Overall, the prior art repair methods that rely on visible and/or ultraviolet light have not optimized critical irradiation conditions including, but not limited to, the time of irradiation, the particular wavelength of the visible and/or ultraviolet light, and the distance at which a source of the visible and/or ultraviolet light is set relative to the substrate coated with the compositions to be cured. Furthermore, such repair methods have not successfully combined more than one composition for cure by visible and/or ultraviolet light. Consequently, like the other conventional methods described above, these methods are not able to accomplish the repair in a sufficiently short period of time. One example of a method that employs visible and/or ultraviolet light is disclosed in U.S. Pat. No. 6,821,569. However, with reference to Example 1 of the '569 patent, its repair method takes at least 35 minutes overall (including application of a body filler referred to as a putty composition) and at least 25 minutes for application and cure and/or dry of the primer composition, the basecoat composition, and the clearcoat composition.

Due to the limitations in the prior art repair methods described above, end-of-line (EOL) repair shops within OEM production facilities are frequently a critical ‘bottleneck’ in the overall production process. These limitations described above also negatively impact refinish repair facilities whereby the finishes on the vehicles cannot be repaired quickly enough.

### SUMMARY OF THE INVENTION

A method of repairing an area of damage of a finish on a substrate is disclosed. The method includes applying an ultraviolet-curable primer composition to the area of damage on the substrate. The ultraviolet-curable primer composition is force flashed. Light is irradiated to cure the ultraviolet-curable primer composition thereby forming a cured primer layer. The light is irradiated at a wavelength of 315 to 700 nm to cure the ultraviolet-curable primer composition. A basecoat composition is applied to the cured primer layer. The basecoat composition is force flashed thereby forming a dried basecoat layer. An ultraviolet-curable clearcoat composition is applied to the dried basecoat layer. The ultraviolet-curable clearcoat composition is force flashed, and light is irradiated at a wavelength of 315 to 700 nm to cure the ultraviolet-curable clearcoat composition thereby forming a cured clearcoat layer.

The repair method of the subject invention can be completed in approximately 10 minutes. Accordingly, this repair method quickly repairs the damaged finish especially as compared to those methods of the prior art, even those that currently rely on irradiation of visible and/or ultraviolet light. This repair method also enables use of various compositions that are free of isocyanates while still, after repair, providing the finish with sufficiently durability. Finally, by accomplishing such a quick repair and enabling use of isocyanate-free compositions, the subject method clearly reduces the ‘bottleneck’ existing in the prior art methods of repair and is, therefore, ideal for wide ranging implementation in both OEM production facilities and refinish repair facilities.

### DETAILED DESCRIPTION OF THE INVENTION

A method of repairing an area of damage of a finish on a substrate is necessary because, as suggested above, it is frequently desirable to return the damaged finish to its original color and/or appearance on the substrate after the area has been damaged. This method results in a repaired finish that sufficiently matches the original finish on the substrate in color and/or appearance.

The method of the subject invention can be conducted in a wide range of facilities including, but not limited to, original equipment manufacturer (OEM) production facilities and in refinish repair facilities. As an example, when the substrate is a body panel of a vehicle and the body panel has been damaged as a result of an accident, such as a collision, in the facility or as a result of an error during application, such as during spraying, of original coating compositions to produce the finish, it is desirable to repair the area of damage and return the finish to its original color and/or appearance. In an OEM production facility, it is especially desirable to use the repair method of the subject invention to repair the area of damage in lieu of completely repainting the vehicle.

Notably, the repair method of the subject invention can be applied to a wide variety of substrates including those not limited to vehicles and, in the context of vehicles, this repair method can be applied to vehicles other than automobiles including, but not limited to, trains, airplanes, heavy duty vehicles, and the like. The body panel of the vehicle can be metal (e.g. quarter panel, door, etc.), plastic (bumper, exterior mirror, etc.), or any other material of construction suitable for a vehicle.

The method includes applying an ultraviolet-curable (UV-curable) primer composition to the area of damage on the substrate. The method also includes application of a basecoat composition and a UV-curable clearcoat composition. The application of the basecoat and UV-curable clearcoat compositions and the particulars of each of these compositions are described additionally below.

The UV-curable primer composition is preferably spray-applied to a film build of 1.5 to 2.5, more preferably 1.8 to 2.2, mils. The UV-curable primer composition can be applied in one pass or in more than one pass. The UV-curable primer composition preferably comprises a urethane acrylate polymer, a diacrylate monomer, and a primer photoinitiator. The preferred UV-curable primer composition is also a one-component (1 K) system that is free of isocyanates. In this preferred embodiment, the diacrylate monomer is, more specifically, an acrylic acid ester, such as Laromer® TPGDA (tripropylene glycol diacrylate) which is commercially available from BASF Aktiengesellschaft of Ludwigshafen, Germany, and the primer photoinitiator more specifically comprises benzophenone, i.e., diphenyl ketone, hydroxyphenyl ketone (HPK), or alpha-hydroxy ketone (AHK). Of course, other primer photoinitiators are suitable for incorporation into the UV-curable primer composition so long as the primer photoinitiator can initiate free-radial polymerization of the UV-curable primer composition upon exposure to visible and/or ultraviolet (UV) light. Examples of suitable UV-curable primer compositions include, but are not limited to, those commercially available from BASF Corporation of Southfield, Mich. under the trade name R-M AM826 UV Primer and R-M VP126 UV Primer Surfacer and under the tradename Glasurit® 185-10 and/or Glasurit® 151-70.

Optionally, the area of damage may be prepared prior in some manner prior to application of the UV-curable primer composition. In fact, although not required, the area of damage is typically prepared, i.e., prepped, in some manner. Various techniques for preparing the area of damage include application of a body filler, cleaning, sanding, grinding, wiping, solvent wiping, blowing, tacking, and the like. These techniques can be conducted in any order. Once the damaged area is appropriately prepared, the UV-curable primer composition is typically applied. Although not required, the optional body filler can also be curable by UV energy.

Whether the area of damage first requires preparation or not, the UV-curable primer composition is force flashed with pressurized ambient or heated air. In other words, the UV-curable primer composition is actively or positively flashed rather than merely permitting the applied UV-curable primer composition to “breathe”, meaning passively, partially air-drying at ambient temperature upon application, generally for a short period of time. Preferably, the UV-curable composition is force flashed after the UV-curable primer composition has been applied. On the other hand, although it is not preferred, the force flash may occur during, i.e., simultaneous with, application of the UV-curable primer composition. For example, the force flash could be introduced in between passes during the application of the UV-curable primer composition. As realized in the context of the Examples below, the force flash of the UV-curable primer composition, in combination with the particular irradiation conditions and force flashes of the basecoat and UV-curable clearcoat compositions, directly impacts the ability of the subject method to accomplish the repair in approximately 10 minutes. The force flashing at least partially or completely dries the UV-curable primer composition. As is known in the art, drying of a composition involves the evaporation of volatiles, such as solvent or water or both. Drying is to be distinguished from curing which involves chemical cross-linking of a particular composition.

Preferably, the UV-curable primer composition is force flashed with ambient air at 5 to 20 cfm (ft³/min) for 0.5 to 2.5 minutes. Depending on many factors appreciated by those skilled in the art, the temperature of ambient air generally ranges from 65 to 95° F. Preferably, at the cfms set forth above, a source of the force flashing of the ambient air is positioned from 6 to 24 inches away from the damaged area on the substrate. The source of the force flashing is described additionally below. The cfm is simply a measure of air volume output and is related to an inlet pressure of air that supplies the source of the force flashing. Typically, the inlet pressure ranges from 20 to 80, more typically about 60, PSI. Most preferably, the UV-curable primer composition is force flashed with ambient air at 10 to 15 cfm for 1.0 to 1.5 minutes at approximately 12 inches away from the damaged area on the substrate.

The source for the force flashing can be hand held or can be adjustably mounted to a support mechanism. Suitable sources include, but are not limited to, Jet Dry Blow Guns commercially available from SATA Farbspritztechnik GmbH & Co. KG, of Kornwestheim, Germany, AeroDry™ Paint Dryer Systems commercially available from DeVilbiss, a division of ITW Automotive Refinishing, and Hydromate Air Moving Systems commercially available from Edwin Trisk Limited. These and other sources for the forced flash typically include specialized nozzle designs to appropriately adjust and/or control air volume output. Generally, the air volume output is from 10 to 20, more typically from 15 to 18, times the inlet pressure to the source for the force flashing.

Alternatively, the UV-curable primer composition can be force flashed with air greater than 95° F. and ranging up to 110° F. at similar cfms, similar times, and similar source-to-substrate positions, i.e., distances. It is to be appreciated by those skilled in the art that the particular temperature of the air for force flashing the UV-curable primer composition, such as an elevated temperature of 100° F., can enable force flashing at different cfms, different times, and different source-to-substrate positions, most typically less cfms, less times, and a greater source-to-substrate positions. It is also to be appreciated by those skilled in the art that the temperature of the air can be modified to achieve these slightly elevated temperatures through unique designs in the source whereby incoming air is heated as it flows through the source, or through increasing a temperature of the repair line and/or repair booth above ambient.

Light, or radiation, is irradiated at a wavelength of 300 to 700, preferably of 315 to 500, more preferably of 320 to 420, nm to cure the UV-curable primer composition thereby forming a cured primer layer. Preferably, the light is irradiated at the aforementioned wavelengths at a distance of 1 to 8, more preferably 2 to 3, inches from the substrate. It is also preferred that the light is irradiated for 1 to 2, more preferably for approximately 1.5, minutes to cure the UV-curable primer composition. As understood by those skilled in the art, the distance at which the light is irradiated relative to the substrate impacts intensity and, therefore, the time required to achieve cure of the respective composition, such as the UV-curable primer composition or the UV-curable clearcoat composition. The light is typically irradiated once the UV-curable primer composition has been force flashed. The force flashing dries, not cures, the UV-curable primer composition into a dried primer layer and it is this dried primer layer that is exposed to the irradiated light to form the cured primer layer. Alternatively, the light can be irradiated to cure the UV-curable primer composition simultaneous with the force flashing of the UV-curable primer composition.

At these wavelengths, the light that is irradiated is in the visible or ultraviolet (UV) regions of the electromagnetic spectrum. Within the UV region and the applicable wavelengths set forth above, the light can be further categorized as UV-A and UV-B. Various light sources for irradiating the light at the wavelengths set forth above are known in the art. These light sources are typically generally categorized as UV-A lamps. These light sources may or may not have ‘light’ filters. As a non-limiting example, one such light source is commercially available from UVIEW Ultraviolet Systems, Inc. of Mississauga, Ontario under the trade name Xpress Cure™ UV Curing System and Part No. 410000. As a further non-limiting example, another such light source is commercially available from Panacol-Elosol, GmbH-under their UV Lamp product offerings (hand lamp, point source lamp, flood lamp, etc.). However, it is also contemplated that, at the particular wavelengths set forth herein, the repair method of the subject invention is also useful relying on sunlight to irradiate and cure the respective compositions.

Upon exposure of the area of damage, now having the applied and force flashed UV-curable primer composition, to the irradiated light at the above wavelengths, the primer photoinitiator initiates free-radial polymerization of the UV-curable primer composition and cures the UV-curable primer composition to form the cured primer layer.

Optionally, the cured primer layer may be sanded and the sanded primer layer may be cleaned prior to application of the basecoat composition as described immediately below. If the cured primer layer is to be sanded, it is desirable for the cured primer layer to first be wiped with a suitable solvent to prepare the primer layer for easier sanding. Although not required, for ideal sanding of the cured primer layer, 400 grit sand paper or finer is used and the cured primer layer is sanded with this paper either in a wet sanding technique or a dry sanding technique. Whether wet or dry, the sanding can be manual or can be automated with the assistance of an air-driven rotary sander known to those skilled in the art. Once sanded, the sanded primer layer is then typically cleaned by wiping and/or solvent wiping and/or blowing and/or tacking. A suitable cleaner can be used after sanded to ultimately prepare the sanded primer layer for application of the basecoat composition.

The basecoat composition, originally introduced above, is applied to the cured primer layer. The basecoat composition typically includes pigments, normally introduced in the form of pigment dispersions, to match the original color of the finish. In addition to standard pigments known to those skilled in the art, these pigments can include special effect pigments, such as aluminum and/or mica flakes. The basecoat composition is preferably spray-applied to hiding, which can vary based on the color, but is typically applied to a film build of 0.5 to 2.0, more typically 0.8 to 1.2, mils. The basecoat composition can be applied in one pass or in more than one pass. The basecoat composition can be either solventborne or waterborne. Most preferably, the basecoat composition is a refinish basecoat composition that is free of isocyanates and is chemically based on urethanes, acrylics, polyesters, polyethers, cellulose acetate butyrate, and/or the like. Non-limiting examples of suitable basecoat compositions include Glasurit® 55 Line White Basecoat and 90 Line White Basecoat commercially available from BASF Corporation of Southfield, Mich.

Like the UV-curable primer composition, the basecoat composition is force flashed thereby forming a dried basecoat layer. In other words, just like the UV-curable primer composition, the basecoat composition is actively or positively flashed rather than merely permitting the applied basecoat composition to breathe upon application. Typically, the basecoat composition is force flashed after the basecoat composition has been applied. However, in an alternative embodiment, the basecoat composition may be force flashed during, i.e., simultaneous with, application of the basecoat composition. For example, the force flash could be introduced in between passes during the application of the basecoat composition. As realized in the context of the Examples below, the force flash of the basecoat composition, in combination with the particular irradiation conditions and force flashes of the UV-curable primer and UV-curable clearcoat compositions, directly impacts the ability of the subject method to accomplish the repair in approximately 10 minutes. The force flashing at least partially or completely dries the basecoat composition to form the dried basecoat layer.

Preferably, the basecoat composition is force flashed with ambient air at 5 to 20 cfm for 0.5 to 2.5 minutes. Preferably, at the cfms set forth above, the source of the force flashing of the ambient air is positioned from 6 to 24 inches away from the damaged area on the substrate. Most preferably, the basecoat composition is force flashed with ambient air at 10 to 15 cfm for 1.0 to 1.5 minutes at approximately 12 inches away from the damaged area on the substrate. The source of the force flashing and the various conditions associated with the force flashing of the basecoat composition (e.g. inlet pressure) can be the same or different as the source of the force flashing for the UV-curable primer composition and the UV-curable clearcoat composition.

Alternatively, the basecoat composition can be force flashed with air at greater than 95° F. and ranging up to 1110° F. at similar cfms, similar times, and similar source-to-substrate positions, i.e., distances. It is to be appreciated by those skilled in the art that the particular temperature of the air for force flashing the basecoat composition, such as an elevated temperature of 100° F., can enable force flashing at different cfms, different times, and different source-to-substrate positions, most typically less cfms, less times, and a greater source-to-substrate positions. As with the force flashing of the UV-curable primer composition, it is also to be appreciated by those skilled in the art that the temperature of the air can be modified to achieve these slightly elevated temperatures through unique designs in the source whereby incoming air is heated as it flows through the source, or through increasing a temperature of the repair line and/or repair booth above ambient temperatures.

The UV-curable clearcoat composition, originally introduced above, is applied to the dried basecoat layer. The UV-curable clearcoat composition is preferably spray-applied to a film build of 1.5 to 2.5, more preferably 1.8 to 2.2, mils. The UV-curable clearcoat composition can be applied in one pass or in more than one pass. The UV-curable clearcoat composition preferably comprises an aliphatic urethane acrylate polymer and a clearcoat photoinitiator. Of course, the clearcoat composition can be based on other polymers than the aliphatic urethane acrylate polymer, such as polyesters, unmodified acrylics, unmodified urethanes, etc. The UV-curable clearcoat composition may, optionally, include additives including, but not limited to, ultraviolet absorbers (UVAs), hindered amine light stabilizers (HALS), and the like. Like the UV-curable primer composition, the preferred UV-curable clearcoat composition is also a one-component (1 K) system that is free of isocyanates. In this preferred embodiment, the clearcoat photoinitiator more specifically comprises bis-acyl phosphine oxide (BAPO). Of course, other clearcoat photoinitiators are suitable for incorporation into the UV-curable clearcoat composition, such as the photoinitiators outlined above relative to the UV-curable primer composition, so long as the clearcoat photoinitiator can initiate free-radial polymerization of the UV-curable clearcoat composition upon exposure to visible and/or UV light: The primer photoinitiator and the clearcoat photoinitiator can be the same or different. Examples of suitable UV-curable clearcoat compositions include, but are not limited to, those available from BASF Corporation of Southfield, Mich. Finally, the UV-curable clearcoat composition can be either solventborne or waterborne.

Like the UV-curable primer composition and the basecoat composition, the clearcoat composition is force flashed with ambient or heated pressurized air. In other words, just like the UV-curable primer composition and the basecoat composition, the UV-curable clearcoat composition is actively or positively flashed rather than merely permitting the applied UV-curable clearcoat composition to passively air-dry under ambient conditions upon application. Typically, the UV-curable clearcoat composition is force flashed after the UV-curable clearcoat composition has been applied. However, in an alternative embodiment, the UV-curable clearcoat composition may be force flashed during, i.e., simultaneous with, application of the UV-curable clearcoat composition. For example, the force flash could be introduced in between passes during the application of the UV-curable clearcoat composition. As realized in the context of the Examples below, the force flash of the UV-curable clearcoat composition, in combination with the particular irradiation conditions and force flashes of the UV-curable primer composition and the basecoat composition, directly impacts the ability of the subject method to accomplish the repair in approximately 10 minutes. The force flashing at least partially or completely dries the UV-curable clearcoat composition.

Preferably, the UV-curable clearcoat composition is force flashed with ambient air at 5 to 20 cfm for 0.5 to 2.5 minutes. Preferably, at the cfms set forth above, the source of the force flashing of the ambient air is positioned from 6 to 24 inches away from the damaged area on the substrate. Most preferably, the UV-curable clearcoat composition is force flashed with ambient air at 10 to 15 cfm for 1.5 to 2.0 minutes at approximately 12 inches away from the damaged area on the substrate. The source of the force flashing and the various conditions associated with the force flashing of the UV-curable clearcoat composition (e.g. inlet pressure) can be the same or different as the source of the force flashing for the UV-curable primer composition and the basecoat composition.

Alternatively, the UV-curable clearcoat composition can be force flashed with air at greater than 95° F. and ranging up to 110° F. at similar cfms, similar times, and similar source-to-substrate positions, i.e., distances. It is to be appreciated by those skilled in the art that the particular temperature of the air for force flashing the UV-curable clearcoat composition, such as an elevated temperature of 100° F., can enable force flashing at different cfms, different times, and different source-to-substrate positions, most typically less cfms, less times, and a greater source-to-substrate positions. As with the force flashing of the UV-curable primer composition and the basecoat composition, it is also to be appreciated by those skilled in the art that the temperature of the air can be modified to achieve these slightly elevated temperatures through unique designs in the source whereby incoming air is heated as it flows through the source, or through increasing a temperature of the repair line and/or repair booth.

Light, or radiation, is irradiated at a wavelength of 300 to 700, preferably of 315 to 500, more preferably of 320 to 420, nm to cure the UV-curable clearcoat composition thereby forming a cured clearcoat layer. Preferably, the light is irradiated at the aforementioned wavelengths at a distance of 1 to 15, more preferably 5 to 10, and most preferably 6 to 8, inches from the substrate. It is also preferred that the light is irradiated for 1 to 3, more preferably for approximately 1.5 to 2.0, minutes to cure the UV-curable clearcoat composition. The light is typically irradiated after the UV-curable clearcoat composition has been force flashed. The force flashing dries, not cures, the UV-curable clearcoat composition into a dried clearcoat layer and it is this dried clearcoat layer that is exposed to the irradiated light to form the cured clearcoat layer. Alternatively, the light can be irradiated to cure the UV-curable clearcoat composition simultaneous with the force flashing of the UV-curable clearcoat composition.

At these wavelengths, the light that is irradiated is in the visible or ultraviolet (UV) regions of the electromagnetic spectrum. The description above relating to the various light sources for irradiating the light to cure the UV-curable primer composition applies to the light sources that can be applied to irradiate light to cure the UV-curable clearcoat composition. However, it is to be understood that there is no requirement that the light sources for curing the UV-curable primer composition and the UV-curable clearcoat composition be the same. That is, one particular light source may be used to irradiate light to cure the UV-curable primer composition while another type of light source may be used to irradiate light to cure the UV-curable clearcoat composition.

Upon exposure of the area of damage, now having the applied and force flashed UV-curable primer composition, the force flashed basecoat composition, and the applied and force flashed UV-curable clearcoat composition, to the irradiated light at the above wavelengths, the clearcoat photoinitiator initiates free-radial polymerization of the UV-curable clearcoat composition and cures the UV-curable clearcoat composition to form the cured clearcoat layer and complete the repair method of the subject invention.

As alluded to above, the UV-curable primer composition, the basecoat composition, and the UV-curable clearcoat composition are all preferably spray applied to ultimately form their respective layers. It is known in the art that there are various spray application techniques including, but not limited to, rotary spray application and air-atomized spray application (including HVLP spray application). Although all of the compositions are preferably spray applied, each composition can independently be applied by other application techniques known to those skilled in the art including, but not limited to, dipping and rolling. The compositions can be applied manually or automatically with the assistance of known spray mechanisms and/or spray robots.

As is evidenced by the Examples immediately below, unlike any other repair method involving a primer composition, a basecoat composition, and a clearcoat composition, the method of the present invention is able to complete the repair in approximately 10 minutes from the beginning of application of the UV-curable primer composition to the irradiation of light to cure the UV-curable clearcoat composition to form the cured clearcoat layer.

The following Examples illustrating the performance and completion of the method of repairing an area of damage of a finish on a substrate of a vehicle according to the subject invention, as presented herein, are intended to illustrate and not to limit the invention.

### EXAMPLES

### In Example 1

The UV-curable primer composition is R-M AM826 UV Primer commercially available from BASF Corporation of Southfield, Mich., the basecoat composition is Glasurit® 55 Line White Basecoat commercially available from BASF Corporation of Southfield, Mich., and the UV-curable clearcoat composition is prepared according to the % s in the Table below.

| UV-Curable Clearcoat Composition | Amount |
|---|---|
| Component | (%) |
| n-Butyl Acetate | 13.9 |
| Propylene Glycol Monomethyl Ether Acetate | 30.6 |
| Ethyl-3-Ethoxy Propionate | 2.0 |
| Hindered Amine Light Stabilizer (HALS) | 0.8 |
| Ultraviolet Absorber (UVA) | 0.8 |
| Aliphatic Urethane Acrylate | 49.8 |
| Flow Modifier | 0.1 |
| Clearcoat Photoinitiator | 2.0 |
| Total | 100.00 |

The UV-curable primer composition is applied by hand spraying a 4″×12″ panel to approximately 2 mils in 2 passes (approximately 1 mil per pass). The UV-curable primer composition is allowed to breathe or flash between each pass for approximately 10 to 15 seconds. The UV-curable primer composition is applied to a bare metal portion of the 4″×12″ panel which is intended to simulate the area of damage of the finish requiring repair. Application of the UV-curable primer composition takes approximately 20 to 40 seconds total, including the approximate 10 to 15 seconds in between passes.

After application of the UV-curable primer composition, the UV-curable primer composition is force flashed to dry the UV-curable primer composition. More specifically, the UV-curable primer composition is force flashed with ambient air at 12 to 13 cfm for approximately 1.0 to 1.5 minutes with the particular source of force flashing being positioned approximately 12 inches away from the damaged area on the 4″×12″ panel. The source of the force flashing is adjustably mounted to a sufficient support mechanism.

Next, light at a wavelength of 320 to 420 nm is irradiated to cure the UV-curable primer composition and form the cured primer layer. The light source is positioned at a distance approximately 3 inches from the 4″×12″ panel and the light is irradiated for approximately 1.5 minutes to cure the UV-curable primer composition. The cured primer layer is then sanded and wiped.

The basecoat composition is applied by hand spraying to the cured primer layer to approximately 1 mil in 2 passes (approximately 0.5 mil per pass). The basecoat composition is allowed to breathe or flash between each pass for approximately 5 to 15 seconds. Application of the basecoat composition takes approximately 15 to 30 seconds total, including the approximate 5 to 15 seconds in between each pass.

After application of the basecoat composition, the basecoat composition is force flashed to dry the basecoat composition thereby forming the dried basecoat layer. More specifically, the basecoat composition is force flashed with ambient air at 12 to 13 cfm for approximately 1.0 to 1.5 minutes with the particular source of force flashing being positioned approximately 12 inches away from the damaged area on the 4″×12″ panel. Just as with the force flashing of the UV-curable primer composition, the source of the force flashing for the basecoat composition is adjustably mounted to a sufficient support mechanism.

Next, the UV-curable clearcoat composition is applied by hand spraying to the dried basecoat layer to approximately 2 mils in 2 passes (approximately 1 mil per pass). The UV-curable clearcoat composition is allowed to breathe or flash between each pass for approximately 5 to 20 seconds. Application of the UV-curable clearcoat composition takes approximately 10 to 30 seconds total, including the approximate 5 to 20 in between passes.

After application of the UV-curable clearcoat composition, the UV-curable clearcoat composition is force flashed to dry the UV-curable clearcoat composition. More specifically, the UV-curable clearcoat composition is force flashed with ambient air at 12 to 13 cfm for approximately 1.5 to 2.0 minutes with the particular source of force flashing being positioned approximately 12 inches away from the damaged area on the 4″×12″ panel. Just as with the force flashing of the UV-curable primer composition and the basecoat composition, the source of the force flashing for the UV-curable clearcoat is adjustably mounted to a sufficient support mechanism.

Finally, light at a wavelength of 320 to 420 nm is irradiated to cure the UV-curable clearcoat composition and form the cured clearcoat layer. The light source is positioned at a distance approximately 5 to 6 inches from the 4″×12″ panel and the light is irradiated for approximately 1.5 to 2.0 minutes to cure the UV-curable clearcoat composition and complete the repair in approximately 10 minutes from the initial application of the UV-curable primer composition.

In Example 2, the same compositions are applied, force flashed, and irradiated in the same manner described above in relation to Example 1. However, in Example 2, the substrate is a body panel of a vehicle rather than the 4″×12″ panel of Example 1. The cured primer layer on the body panel of the vehicle is also sanded and wiped as above in Example 1. In addition to using a different substrate, Example 2 is conducted to evidence repeatability of the approximate 10 minute repair described above.

In both Examples, a solvent sensitivity of the cured primer layer and a solvent sensitivity of the cured clearcoat layer are tested for resistance to solvent wiping with methyl ethyl ketone (MEK).

The invention has been described in an illustrative manner, and it is to be understood that the terminology that has been used is intended to be in the nature of words of description rather than of limitation. Obviously, many modifications and variations of the present invention are possible in light of the above teachings, and the invention may be practiced otherwise than as specifically described.

What is claimed is:

1. A method of repairing an area of damage of a finish on a substrate, said method comprising the steps of:
applying an ultraviolet-curable primer composition to the area of damage on the substrate;
force flashing the ultraviolet-curable primer composition;
irradiating light at a wavelength of 300 to 700 nm to cure the ultraviolet-curable primer composition thereby forming a cured primer layer;
applying a basecoat composition to the cured primer layer;
force flashing the basecoat composition thereby forming a dried basecoat layer;
applying an ultraviolet-curable clearcoat composition to the dried basecoat layer;
force flashing the ultraviolet-curable clearcoat composition; and
irradiating light at a wavelength of 300 to 700 nm to cure the ultraviolet-curable clearcoat composition thereby forming a cured clearcoat layer.

2. A method as set forth in claim 1 wherein the ultraviolet-curable primer composition, the basecoat composition, and the ultraviolet-curable clearcoat composition are force flashed with air at greater than 95° F. and up to 110° F. at 5 to 20 cfm for 0.5 to 2.5 minutes.

3. A method as set forth in claim 1 wherein the ultraviolet-curable primer composition, the basecoat composition, and the ultraviolet-curable clearcoat composition are force flashed with ambient air at 5 to 20 cfm for 0.5 to 2.5 minutes.

4. A method as set forth in claim 3 further comprising the steps of sanding the cured primer layer and cleaning the sanded primer layer prior to application of the basecoat composition.

5. A method as set forth in claim 3 wherein the step of irradiating light at a wavelength of 300 to 700 nm to cure the ultraviolet-curable primer composition comprises irradiating light at a wavelength of 315 to 500 nm and 1 to 8 inches from the substrate.

6. A method as set forth in claim 5 wherein the light is irradiated for 1 to 2 minutes to cure the ultraviolet-curable primer composition.

7. A method as set forth in claim 5 wherein the step of irradiating light at a wavelength of 300 to 700 nm to cure the ultraviolet-curable clearcoat composition comprises irradiating light at a wavelength of 315 to 500 nm and 5 to 10 inches from the substrate.

8. A method as set forth in claim 7 wherein the light is irradiated for 1 to 3 minutes to cure the ultraviolet-curable clearcoat composition.

9. A method as set forth in claim 1 wherein the basecoat composition is selected from the group of solventborne basecoat compositions and waterborne basecoat compositions.

10. A method as set forth in claim 1 wherein the basecoat composition is free of isocyanates.

11. A method as set forth in claim 1 wherein the basecoat composition is further defined as a refinish basecoat composition.

12. A method as set forth in claim 1 wherein the ultraviolet-curable primer composition comprises a urethane acrylate polymer, a diacrylate monomer, and a primer photoinitiator.

13. A method as set forth in claim 12 wherein the primer photoinitiator is selected from the group of benzophenone, hydroxyphenyl ketone (HPK), alpha-hydroxy ketone (AHK), and combinations thereof.

14. A method as set forth in claim 1 wherein the ultraviolet-curable clearcoat composition comprises an aliphatic urethane acrylate polymer and a clearcoat photoinitiator.

15. A method as set forth in claim 14 wherein the clearcoat photoinitiator comprises bis-acyl phosphine oxide (BAPO).

16. A method as set forth in claim 1 further comprising the step of preparing the area of damage prior to the application of the ultraviolet-curable primer composition.

17. A method as set forth in claim 16 wherein the step of preparing the area of damage comprises applying a body filler to the area of damage.

18. A method as set forth in claim 1 wherein the substrate is further defined as a body panel of a vehicle and said method is conducted in an original equipment manufacturer (OEM) production facility.

19. A method as set forth in claim 1 wherein the substrate is further defined as a body panel of a vehicle and said method is conducted in a refinish repair facility.

20. A method as set forth in claim 1 wherein the light is irradiated to cure the ultraviolet-curable primer composition simultaneous with the force flashing of the ultraviolet-curable primer composition.

21. A method as set forth in claim 1 wherein the light is irradiated to cure the ultraviolet-curable clearcoat composition simultaneous with the force flashing of the ultraviolet-curable clearcoat composition.
